(19) United States
(12) Patent Application Publication
(10) Pub. No.: US 2012/0043085 A1
(43) Pub. Date: Feb. 23, 2012

(54) WELLBORE SERVICE FLUID AND METHODS OF USE

(75) Inventor: Dean Willberg, Salt Lake City, UT (US)

(73) Assignee: SCHLUMBERGER TECHNOLOGY CORPORATION, Cambridge, MA (US)

(21) Appl. No.: 12/859,349

(22) Filed: Aug. 19, 2010

(51) Int. Cl. E21B 43/26; C09K 8/62; E21B 43/16

(52) U.S. Cl. 166/308.1; 166/305.1; 507/269; 507/267; 507/200; 507/273; 507/274; 507/219

(57) ABSTRACT

A method is described to predict the composition of favorable bridging agents for a particular situation in which the solution thermodynamics of the chemicals used in the composition of the bridging material is carefully evaluated. Wellbore service fluids are also described that contain materials such as sodium bicarbonate, a material such as a salt containing water in a crystal structure, a material containing at least one boron-oxygen bond, or a non-polymer material having low solubility at low temperatures and high solubility at temperatures close to an expected long-term static bottom hole temperature. The material is provided in aqueous medium in sufficient concentration in the aqueous medium so as to act as a diverting agent during a hydraulic fracturing procedure using the fluid. The wellbore service fluid is pumped through the wellbore and the flow of the fluid is diverted using a plug that subsequently substantially dissolves due to changes in temperature and/or pressure.

### BACKGROUND

1. Field

This patent specification relates generally to hydraulic fracturing in wellbore applications. More particularly, this patent specification relates to self-degrading diverting agents for use in hydraulic fracturing applications.

2. Background

The physical diversion of hydraulic fracturing fluids, either in the fracture, fracture network, or even in the wellbore by solid bridging agents is a developing field of technology—particularly in unconventional gas plays such as tight sandstones, gas shales and coal bed methane (CBM). In some cases diverting agents are added with the intent of increasing fracture complexity, in other cases they are added with the intent of minimizing flow into natural fractures and keeping as much as possible of the fluid in the primary induced fracture. In other cases they are added with the intention of plugging perforations, or even of plugging wellbores. The diverting agents are typically added during pumping with the intent of influencing the geometry of the created fracture or fracture network.

Diversion during hydraulic fracturing operations with permanent diverting agents such as silica flour and fine mesh sand is an established practice in the oilfield. Diversion with temporary (or degradable) agents such as rock salt, oil soluble resins, waxes and benzoic acid flakes is also practiced in the field. Diversion with degradable polymer fibers and particulates composed of polylactic acid (PLA) or other hydrolysable polymers is also practiced.

Degradable bridging agents are of particular interest because they can be used during a hydraulic fracturing treatment to cause diversion, but since they degrade or dissolve, the subsequent negative impact on fracture conductivity will be minimized. One of the major difficulties with deploying diverting agents is they are often too effective and cause a screenout in the near wellbore region of the fracture, perforations or even in the wellbore. A screenout may cause preliminary termination of the job, leaving too small of a fracture in place, and it may require an expensive coiled tubing cleanout operation to fix. Having a rapidly degrading or even reversible diverting agent could be very useful for situations where screenout potential is high, or where a screenout is particularly troublesome or costly to repair.

A second major difficulty is to formulate low temperature diverting agents for situations where the bottom hole static temperature (BHST), the temperature of the undisturbed formation at the final depth in a well, is only slightly higher than the surface pumping temperature. Hydrolysable polymers such as PLA can take relatively long times to decompose at temperatures less than 100° C.

### SUMMARY

According to some embodiments a wellbore service fluid is provided. The fluid includes an aqueous medium; and sodium bicarbonate in sufficient concentration in the aqueous medium so as to act as a diverting agent during a hydraulic fracturing procedure using the fluid. According to some embodiments, the concentration of sodium bicarbonate is greater than about 96 kg per 1000 liters of aqueous medium. The fluid can also contain a hydrolysable ester such as ethyl acetate or ethyl lactate. The sodium bicarbonate is formed into particles which can be homogeneous, or a composite of the sodium bicarbonate and one or more other materials. According to some embodiments, the particles are encapsulated. The fluid can also include a retarded acid source, such as an encapsulated acidic material or an acidic precursor.

According to some embodiments a wellbore fluid is provided that contains an aqueous medium; and a material containing water in a crystal structure of the material, with the material being in sufficient concentration in the aqueous medium so as to act as a diverting agent during a hydraulic fracturing procedure using the fluid. The material, for example, can be a salt, or a material such as borax.

According to some embodiments, a wellbore service fluid is provided that includes an aqueous medium; and a material containing at least one boron-oxygen bond. The material is provided in sufficient concentration in the aqueous medium so as to act as a diverting agent during a hydraulic fracturing procedure using the fluid. The material, for example, can be granular borax, tincal, tincalonite, kernite, colemanite, ulexite, proberite, hydroboracite, inderite, dalotite, boron trioxide, szaibelyite or sassolite B(OH)₃.

According to some embodiments, a wellbore service fluid is provided that includes an aqueous medium; and a non-polymer material having low solubility at low temperatures and high solubility at temperatures close to an expected long term static bottom hole temperature. The material is provided in sufficient concentration in the aqueous medium so as to act as a diverting agent during a hydraulic fracturing procedure using the fluid.

According to some embodiments a method of fracturing a subterranean formation penetrated by a wellbore, is provided that includes pumping the wellbore service fluid through the wellbore and into the subterranean formation at a pressure sufficient to treat the formation, and diverting flow of the fluid at least in part through formation of a plug that subsequently substantially dissolves at least in part due to changes in temperature and/or pressure.

According to some embodiments, a method of fracturing a subterranean formation penetrated by a wellbore, is provided that includes combining at least a first reactive chemical and a second reactive chemical in an aqueous medium at a pressure of at least 500 psi to form a wellbore service fluid; and pumping the service fluid through the wellbore and into the subterranean formation at a pressure sufficient to fracture the formation.

Further features and advantages will become more readily apparent from the following detailed description when taken in conjunction with the accompanying drawings.

### BRIEF DESCRIPTION OF THE DRAWINGS

The present disclosure is further described in the detailed description which follows, in reference to the noted plurality of drawings by way of non-limiting examples of exemplary embodiments, in which like reference numerals represent similar parts throughout the several views of the drawings, and wherein:

FIG. 1A is a schematic illustrating a hydraulic fracturing process, according to some embodiments;

FIGS. 1B-D illustrate the bridging process and changes in the local solid volume fraction throughout the process of creating and dissolving a diversion plug, according to some embodiments;

FIG. 2 is a flowchart showing steps of a method for selecting the optimum materials or chemical compositions for degradable plugs, according to some embodiments;

FIG. 3 is a graph showing the mass of solids in a slurry of rock salt as a function of the mass of NaCl added to water, according to some embodiments;

FIG. 4 is a graph showing how the solid mass of an NaCl plug changes as a function of temperature and pressure, according to some embodiments;

FIG. 5 is a graph showing the solid volume of an NaCl plug at 10,000 psi as a function of temperature, and as a function of increasing water, according to some embodiments;

FIG. 6 is a graph comparing the equilibrated solid volume fractions for a number of inorganic materials as a function of the added material, according to some embodiments;

FIG. 7 is a graph showing how the solid mass of a diversion plug made with borax will change as a function of temperature and pressure, according to some embodiments;

FIG. 8 is a graph showing how much additional water is required for a borax plug to be removed when the static pressure is 6,000 psi, according to some embodiments;

FIG. 9 is graph illustrating how a V_{sf}^{b}=0.60 solid fraction plug initially made with B₂O₃ dissolves as a function of temperature, according to some embodiments;

FIG. 10 is a graph showing how the solid mass of a NaHCO₃ plug changes as a function of temperature and pressure, according to some embodiments;

FIG. 11 is a graph showing the sensitivity of a sodium bicarbonate plug to the addition of citric acid, according to some embodiments; and

FIG. 12 is a graph showing a modelling experiment that simulates the reaction after the encapsulation ruptures of a combination citric acid/sodium bicarbonate plug, according to some embodiments.

### DETAILED DESCRIPTION OF THE PREFERRED EMBODIMENTS

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems, processes, and other elements in the invention may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

According to some embodiments, a method is used to select favorable material or chemical compositions of diverting plug agents for a particular reservoir, wellbore, completion and production conditions. According to some embodiments, diverting plug agents fabricated from chemicals and materials are provided that are particularly useful for hydraulic fracturing applications.

A method to predict the composition of favorable bridging agents for a particular situation is described herein in which the solution thermodynamics of the chemicals used in the composition of the bridging material is carefully evaluated. According to some embodiments, the solution thermodynamics are used to determine: (1) the optimum composition of the bridging agent(s) based on the specific physical conditions, particularly changes in temperature, pressure, and chemical composition, during the pumping, placement, isolation, and dissolution phases of the diversion in the completion; (2) compatibility of the diverting agents with other chemical additives such as friction reducers; (3) compatibility with formation salts and formation brine composition; (4) determination of whether or not supplement kinetic control—restricted solubility, multi-phase isolation, encapsulation or some other method of physical isolation or retardation—of dissolution is required for diverting agent functionality; (5) determining the extent of plug dissolution under current field conditions; and (6) determining the optimum situation for complete dissolution and cleanup of plug residue.

According to some other embodiments, the fabrication and use of particulate fluid diversion agents is described that are manufactured from various inorganic and organic chemicals that undergo changes in solid volume, ΔV_{solid}, in response to changes in the local temperature of the plug as well as, or in combination with changes in the local hydrostatic pressure. According to some embodiments, the physical chemical mechanism responsible for ΔV_{solid} can be: (1) a change in the solubility of the material; (2) the evolution of gas; (3) loss or rearrangement of water of hydration; or (3) a chemical reaction between two or more reactive species which results in more soluble species. The particulate materials can be of any shape or size that can be pumped, and they can be fabricated in shapes that either minimize cost or maximize bridging efficiency. The particles can be comprised of homogeneous materials, coated or encapsulated materials, or composites. The particulates can be slurried into single, multi-phased and reactive (acidic or chelate containing) fluids.

According to some embodiments, two or more different types of particulate materials may be added to the same slurry at the same time so that a process beneficial to either the placement or cleanup of the bridging agent may occur. Alternatively, according to some embodiments, one or more of the reactive species could be a liquid or dissolved in the solution. For example, a delayed chemical reaction between dissimilar particles (for example encapsulated sodium bicarbonate beads and benzoic acid flakes) which can minimize the solid volume at high temperatures is a beneficial process. Similar examples include the delayed chemical reaction between sodium bicarbonate and a hydrolysable ester such as ethyl acetate or ethyl lactate.

Specific examples are described herein and include: (1) borax (Na₂B₂O₇.10H₂O), boron oxide (diboron trixoxide, B₂O₃), boric acid (H₃BO₃) and other boron salt containing diverting agents; (2) combinations of boron oxide (diboron trixoxide, B₂O₃) and other boron containing salts plus strong bases; (3) sodium bicarbonate (NaHCO₃) based diverting agents; (4) combinations of sodium bicarbonate (NaHCO₃) plus encapsulated acids or acidic precursors (Esters); (5) various phosphate salts; and (6) diversion optimization by physical isolation of reactive materials.

To highlight some of the benefits of some of the embodiments, their performance is compared with an example of conventional rock salt (NaCl), deployed under similar circumstances. Reducing or raising the local fluid temperature by using an endothermic or exothermic salt in combination with another temperature dependent bridging agent is a third example of a beneficial process, according to some embodiments.

Solid Volume Fraction. In order for a bridging agent to function—that is to jam in the fracture and create a blockage sufficiently strong to re-direct bulk fluid flow into an alternate direction—the particles should exceed a critical concentration. This critical concentration is dependent on many factors, including but not limited to: (a) particle size; (b) particle shape (spherical, fibrous, platelet, etc.); (c) particle/fluid interactions; (d) fluid viscosity; (e) friction angle and the mechanical properties of the particles; (f) the width or diameter of the channel being bridged; (g) slurry velocity; (h) wall roughness and fracture tortuosity; and (i) particle concentration in the slurry (soluble volume fraction in the slurry).

Although particle size and shape are important for understanding the entire bridging and diversion process, as will be mentioned below, these are not issues that are fundamental to many of the embodiments described herein, which can practiced irrespective of the shape or structure of the individual bridging particles.

Once the particle sizes and shapes are set, the particle concentration—or specifically the solid volume fraction, V_{sf}, in the slurry needs to be set. V_{sf} is complicated for particles that can rapidly degrade or dissolve—and it can be difficult to determine how much material should be added to construct a degradable diverting plug. According to some embodiments, the thermodynamic properties of various materials are used in optimizing the solid volume fraction in the slurry and in the fracture for the particular completion being designed.

Although for practical reasons particle concentration is usually measured on the basis of a mass concentration in the fluid—with units such as lbm/1000 gal, or pounds added per gal of fluid (PPA)—it is the space filling volume fraction of the particles in the slurry that is the most important parameter for determining bridging characteristics. V_{sf} is defined as:

$${V}_{sf} = \frac{{V}_{s}}{{V}_{s} + {V}_{l}}$$

V_{sf} is a local variable and it varies spatially and temporally throughout the placement process—from the surface equipment down through to the final placement location in the hydraulic fracture—due to both the active concentration of the particles by bridging processes, by the lost of solid mass due to dissolution and due to the leakoff of liquid into the porous rock. For the purposes of modeling the process throughout the hydraulic fracturing and production stages, V_{sf} is characterized at various stages: (1) V_{sf}ⁱ—as the slurry is initially mixed; (2) V_{sf}^{b}—as the slurry is dehydrated to form the bridge or diverting plug; (3) V_{sf}^{d}—the volume after the decomposition process takes place due to chemical interactions with the residual water in the plug after dehydration; and (4) V_{sf}^{r}—the residual volume after the material is able to come to equilibrium with the formation and excess fluid.

For a particulate diverting agent to be practical for field application it has been found that the following constraints should be met: (1) V_{sf}ⁱ should be sufficiently low that the material can be metered, mixed and pumped with the available equipment. It depends on the shape of the individual particles, their internal friction, and their interactions with the fluid. Generally V_{sf}ⁱ is much smaller for chopped fibers than for spherical particles; (2) V_{sf}^{b} depends on the bridging process and subsequent deformation of the diverting plug. For spherical particles V_{sf}^{b}˜0.6 is the value used herein based on the fundamental properties of granular materials; (3) The optimum value for V_{sf}^{d} depends on the engineering situation in the field. If it is critical that the plug holds for a relatively long period of time then a relatively high value of V_{sf}^{d} approximately equal to V_{sf}^{b} is tolerable, or even desirable. If one wants any premature plugs or screenouts to be quickly correctable then V_{sf}^{d}=0 is the desired value; and (4) For degradable diverting agents V_{sf}^{r} should be as low as possible, that is V_{sf}^{r}=0.

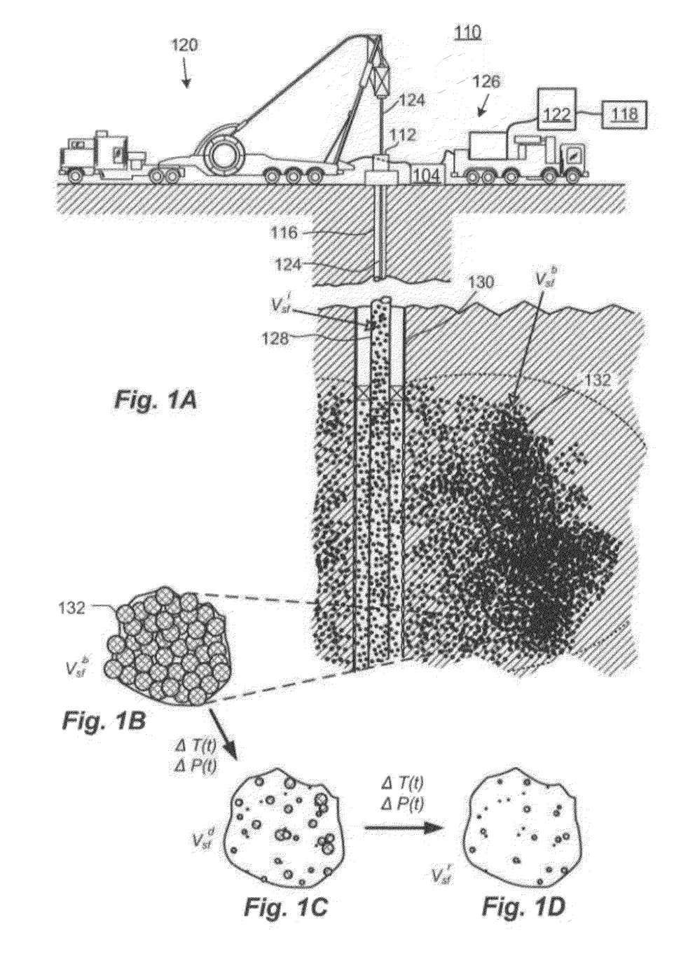

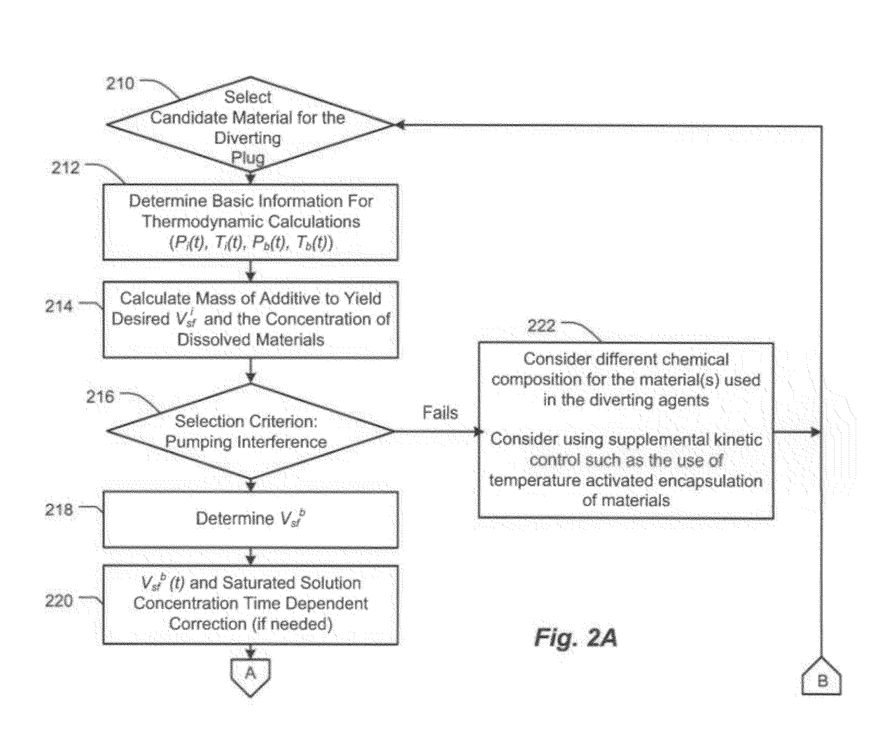

FIG. 1A is a schematic illustrating a hydraulic fracturing process, according to some embodiments. FIGS. 1B-D illustrate the bridging process and changes in the local solid volume fraction throughout the process of creating and dissolving a diversion plug, according to some embodiments. Referring to FIG. 1A, on the surface 110, are a coiled tubing truck 120 and a pumping truck 126. A blender 122 for blending particles 118 into the fracturing fluid is located upstream from the pumping truck 126. The pumping truck pumps fluid into a manifold 104, which is in fluid communication with coiled tubing truck 120, or alternatively, directly into the coiled tubing 124. The tubing 124 enters wellbore 116 via well head 112. At or near the lower end of tubing 124 is frac bottom hole assembly (BHA) 128. Casing 130 is shown in FIG. 1 with perforations, although according to other embodiments, the techniques described operate in open-hole (uncased) application in an analogous manner. According to embodiments, the fracturing fluid includes diverting agent particles. The particle concentration as the slurry is initially mixed, V_{sf}ⁱ is maintained within the coiled tubing 124 and BHA 128. In the formation 150 the particles in the slurry are dehydrated to form the bridge or diverting plug 132 having a concentration of V_{sf}^{b}. FIG. 1B shows a more detailed view of a portion of diverting plug 132 having a concentration of V_{sf}^{b}. FIG. 1C shows detail of the same area as in FIG. 1B, after the change in temperature ΔT(t) and the change in pressure ΔP(t). The concentration is now expresses as V_{sf}^{d} after the decomposition process takes place due to chemical interactions with the residual water in the plug after dehydration. FIG. 1D shows detail of the same area as FIGS. 1B and 1C after the material is able to come to equilibrium with the formation. The residual volume fraction is expressed as V_{sf}^{r}.

Previous experiments have shown that the particle concentrations required to cause bridging depends on the shapes and properties of the materials. For most of the examples presented in this memo we will assume that our bridging agents are spherical particles—as these, or quasi-spheric particles, are in most cases the least expensive to manufacture. From recent field observations, it was found that 2-3 PPA of 40/70 mesh sand can cause screenouts and bridging in many gas shale formations—while still being low enough to be pumped and make it through the perforations in low-viscosity slickwater. A 2.0 PPA slurry of sand corresponds to a V_{sf}ⁱ=0.086. In order for a diverting plug to form, particle velocities in a fracture are retarded with respect to the liquid velocity by friction with the fracture wall, jamming and bridging processes causing the slurry to dehydrate as it proceeds down the fracture, and also causing the local particle concentration to increase. The local particle concentration increases until a diverting plug is formed. Based on the fundamental properties of spherical granular particles, many simulators use V_{sf}^{b}˜0.6 as the critical value for the final solids concentration in a diversion plug. That is, once V_{sf}^{b}=0.6 is reached in any location of the fracture—the “slurry” converts to an immobile porous pack and a diverting plug begins to form, such as plug 132 shown in FIG. 1A.

The input parameters for the calculations described herein are V_{sf}ⁱ=0.10 and V_{sf}^{b}=0.60. These specific input values are for illustration purposes according to other embodiments, other values are used. According to some other embodiments, the same methodology is used for other shaped particles at different solid volume fractions.

For the proper functioning of the described temporary diverting agents, they should last sufficiently long in order to form a plug and divert the flow, but they also eventually decompose and their solid volume should decrease. According to some embodiments, primary focus is placed on two different changes in volume fraction:

ΔV_{sf}^{bd}=V_{sf}^{d}−V_{sf}^{b}

ΔV_{sf}^{bd} is due to chemical reactions or dissolution of the solid fraction with only the fluid remaining in the diverting plug after placement. No flow of water, such as that occurring during flowback, is assumed.

ΔVₛⱼ^{br}=V_{sf}^{r}−V_{sf}^{b}

ΔV_{sf}^{br} is due to chemical reactions or dissolution of the solid fraction with the residual fluid (water) in the plug, and with additional fluid (water) that comes into contact with the plug during flowback and during production.

Calculations are presented herein for systems where the intent is to maximize ΔV_{sf}^{bd}. For plugs to decompose quickly, especially in low-temperature formations, the plug should decompose as much as possible with the residual interstitial water between the particles, and with the water of crystallization—if present, due to local changes in the temperature and pressure ΔT_{local} and ΔP_{local}.

Bridging Plug Degradation. As mentioned in the previously, according to some embodiments, local changes in the temperature and pressure ΔT_{local} and ΔP_{local} cause the eventual degradation of the placed plug. It is known that during hydraulic fracturing treatments the formation rock adjacent to the fracture is significantly cooled by the fluid—especially in large-volume high-rate slickwater jobs. In the modeling work described herein, it is assumed that the plugs are created at ambient temperatures and at the high hydrostatic pressure that occur during pumping. This is an accurate assumption especially for high rate treatments in low temperature formations, especially at times late in the treatment. When pumping ceases, the local temperature in the plug, and surrounding the plug, slowly rises back to the BHST—leading to the dissolution of the diverting plug. However, in many low temperature formations, this temperature recovery can be many hours or days in duration, and can be further delayed by Joule-Thompson cooling caused by the onset of gas production. Therefore, depending on the reservoir conditions the plugs described herein could have effective lifetimes from a few minutes (in high temperature formations) to days (in very low temperature formations). As such it is desirable to have a selection of different plug forming materials that can be effective at different temperature ranges.

Specific Bridging Agents. Specific embodiments will now be highlighted. In particular, descriptions are provided for how diverting agents can be manufactured from the following: (1) borax (Na₂B₂O₇.10H₂O), boron oxide (diboron trixoxide, B₂O₃), boric acid (H₃BO₃) and other boron salts; (2) combinations of boron oxide (diboron trixoxide, B₂O₃); (3) sodium perborate monohydrate (NaBO₃.H₂O) (4) sodium perborate tetrahydrate (NaBO₃.4H₂O) and other perborates; (5) and other boron containing salts plus strong bases; (6) sodium bicarbonate (NaHCO₃); sodium percarbonate (NaCO₃.1.5H₂O₂) and other percarbonates; (7) combinations of sodium bicarbonate (NaHCO₃) plus encapsulated acids or acidic precursors (Esters); and (7) phosphate salts. The described embodiments have been found to be superior to other temporary bridging agents currently used such as rock salt.

According to some embodiments, a particular useful class of bridging agents are chemical species, salts, that contain water of crystallization, or are alternatively known as hydrates. These are salt species that contain water in their crystal structure. These species can be either added to the fluid as the hydrate, or they can be added as anhydrous or partially hydrated salts that form the hydrated species in the water prior to placement in the fracture. Examples are borax (Na₂B₂O₇.10H₂O), which contains 10 moles of water for every mole of Na₂B₂O₇, sodium sulfate decahydrate (Na₂SO₄.10H₂O), ammonium aluminum sulfate ((NH₄)Al(SO₄)₂.12H₂O), potassium aluminium sulfate (KAl(SO₄)₂.12H₂O), and sodium aluminium sulfate ((NH₄)Al(SO₄)₂.12H₂O). These species are particularly useful for diversion plug applications because their solubilities are highly dependent on the temperature. As the temperature increases many of these species can fuse or melt in their own water of hydration. As such theses species would be particularly good for low temperature and applications when the lifetime required for the plug is short.

Salts and hydrates based on phosphate or polyphosphate chemistry are also useful embodiments. Examples of these species are: sodium pyrophosphate decahydrate (Na₂P₂O₇.10H₂O), sodium hydrogen orthophosphate dodecahydrate (Na₂HPO₄.12H₂O), magnesium potassium phosphate hexahydrate (MgKPO₄.6H₂O) and related species. Combinations of various salts and hydrates are also useful as diverting agents in order to optimize the plug formation for different temperature and pressure ranges using the methodology as discussed below.

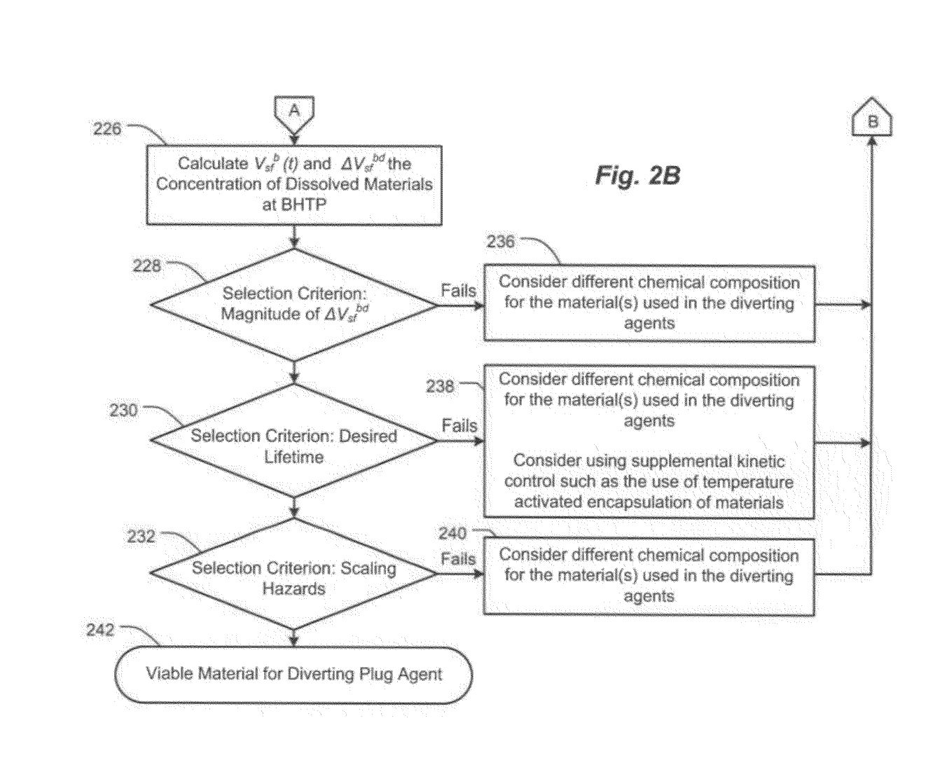

Material Selection Workflow: Solution Thermodynamic Calculations. FIG. 2 is a flowchart showing steps of a method for selecting the optimum materials or chemical compositions for degradable plugs, according to some embodiments. For the calculations presented herein the software program OLIAnalyzer 3.0.6 was used, which can be licensed from OLI Systems Inc., for the thermodynamic calculations of material solubility as a function of temperature, pressure and chemical composition. However, according to other embodiments, other thermodynamic software or suitable database of solubilities as a function of temperature and pressure could be used in the same or similar manner.

In step 210, a candidate material for the diverting plug is selected. In step 212, basic information for thermodynamic calculations is determined, including: Pᵢ(t)=Pressure at the Surface; Tᵢ(t)=Ambient Temperature at the Surface; P_{b}(t)=Bottom Hole Pressure as a Function of Time; and T_{b}(t)=Local Temperature in the Fracture as a Function of Time. In step 214, calculations are made for the mass of additive to yield desired V_{sf}ⁱ and the concentration of dissolved materials. These thermodynamic calculations are performed using the Pᵢ(t), and Tᵢ(t) as input parameters. The calculation of solid volume fraction in the slurry as a function of the mass of diverting agent added to the fluid preferably takes into account the temperature and pressure dependent solubility of the particular material. The mass of additive required to yield the desired V_{sf}ⁱ is determined. For many embodiments described herein, a value of V_{sf}ⁱ=0.10 is used.

In step 216, a selection criterion is applied for pumping interference. If the concentration of dissolved material (e.g. salts) is sufficiently low so as not to interfere with other chemical additives such as friction reducers, proceed to step 218. If V_{sf}ⁱ needs to be increased a check is made to determine if the slurry still pumpable. If the pumping interference criterion is not met, proceed to step 222.

In step 222, different chemical composition for the material(s) used in the diverting agents is considered. Additionally, according to some embodiments, using supplemental kinetic control such as the use of temperature activated encapsulation of materials is considered.

In step 218, V_{sf}^{b} is determined. The determination is based on the particular bridging criteria used for the specific situation, which depends on many factors as described herein. According to some embodiments, V_{sf}^{b}=0.60 is used as the bridging condition. This means that a significant quantity of fracturing fluid saturated in the dissolved bridging material will be squeezed out of the porous diverting plug. V_{sf}^{b} determines the ratio of solid bridging material to saturated solution within the porous bridging plugs, which is an input into the subsequent thermodynamic calculations.

In step 220, a time dependent correction, in some situations, is made for V_{sf}^{b}(t) and the Saturated Solution Concentration. Nominally, V_{sf}^{b} is calculated assuming that there has not been a significantly change in temperature of the slurry between the time of mixing and the time of plug formation. This is a particularly valid assumption for high rate treatments in low temperature formations (especially for diversion plugs close to the wellbore). However, if there has been significant rise in slurry temperature between the time of mixing at the surface and the placement of the plug in the formation V_{sf}^{b}(t) needs to be calculated as a function of time. This can be readily performed by coupling a fracture temperature simulator with the thermodynamic simulator (such as OLI StreamAnalyzer). The mass of diverting agent used and the original V_{sf}ⁱ may also need to be adjusted.

In step 226, calculations are made for V_{sf}^{d} and ΔV_{sf}^{bd}, the concentration of dissolved materials at BHTP. This thermodynamic calculation is done using the P_{b}(t), T_{b}(t), the mass of solid material, and the mass of saturated solution remaining in the porous diverting plug as input parameters. In the calculation ΔV_{sf}^{bd}=V_{sf}^{d}−V_{sf}^{b}.

In step 228, a selection criterion is applied for the magnitude of ΔV_{sf}^{bd}. If ΔV_{sf}^{bd} is sufficiently large to allow for circulation of fluids in the region of placement and through the porous remains of the plug itself then proceed to step 230. Otherwise proceed to step 236. In step 236, a different chemical composition for the material(s) used in the diverting agents is considered.

In step 230, a selection criterion is applied for desired lifetime. Depending on the rate of temperature rise and the magnitude of ΔV_{sf}^{bd}(t), if the plug's lifetime is sufficiently long enough to meet the applications requirements, then proceed to step 232. Otherwise, proceed to step 238. In step 238, a different chemical composition for the material(s) used in the diverting agents is considered. Using supplemental kinetic control such as the use of temperature activated encapsulation of materials may also be considered.

In step 232, a selection criterion is optionally applied for scaling hazards. Using a thermodynamic simulator, a determination of the concentration of dissolved salts from plug dissolution is made. If the concentration is sufficiently high to cause scaling problems when combined with naturally occurring salts in the formation, then proceed to step 240. Otherwise proceed to step 242. In step 240, a different chemical composition for the material(s) used in the diverting agents is considered.

In step 242, a viable material for a diverting plug agent is qualified for the particular application or applications.

Note that the process shown in FIG. 2 does not depend on the specific order of application of many of the steps. For example, according to some embodiments, the order of the last three selection criteria, namely steps 228, 230 and 232 are performed in different orders than as shown in FIG. 2. Additionally, according to some embodiments, certain steps may not be performed. For example, according to some embodiments, steps 214, 216, 220, 230 and/or 232 are not performed for some types of applications.

Example of rock salt (NaCl). An example of applying the analysis techniques to rock salt will now be provided. Rock salt has been used in the field to make diverting plugs, however it is less than ideal for application in ultra low permeability gas shale formations. First, due to its high solubility at ambient temperatures (25° C.) it requires a large excess of material added to the slurry before any remains as a solid bridging agent under equilibrium conditions. In high rate waterfracs it is very likely that NaCl rapidly dissolves during the turbulent transport down the wellbore. As a consequence, 5.3 PPA of NaCl need to be added to a fracturing fluid in order to achieve V_{sf}ⁱ=0.10 under equilibrium conditions at 25° C. Furthermore, the ionic strength of saturated NaCl solutions is very high 320,867 mg/L—sufficiently high to interference with the performance of friction reducers.

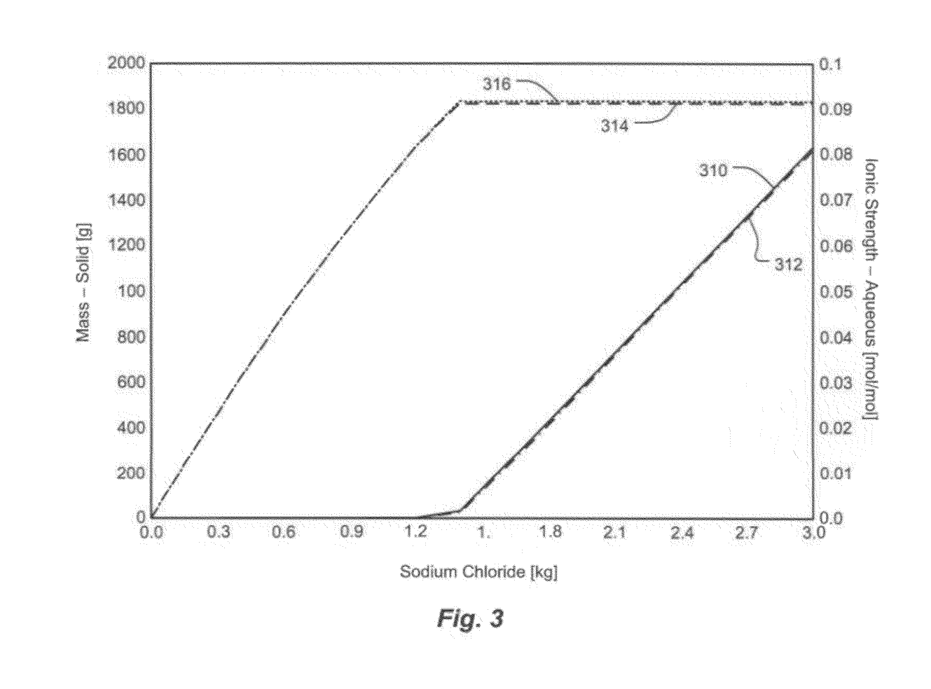

FIG. 3 is a graph showing the mass of solids in a slurry of rock salt as a function of the mass of NaCl added to 3.785 kg (1 gal) of water, according to some embodiments. Curves 310 and 312 plot the mass of solids in a slurry of rock salt as a function of the mass of NaCl added for pressures of 3000 psia, and 6000 psia, respectively. Over 1.35 kg of NaCl need to be added to the slurry before any solid remains at equilibrium conditions. The curves 314 and 316 plot the ionic strength of the aqueous brine in units of (moles ions/total moles of the solution) for pressures of 3000 psia, and 6000 psia, respectively. For comparison with traditional oilfield units, a saturated NaCl solution has a total dissolved solids (TDS) content of TDS=320,867 mg/L.

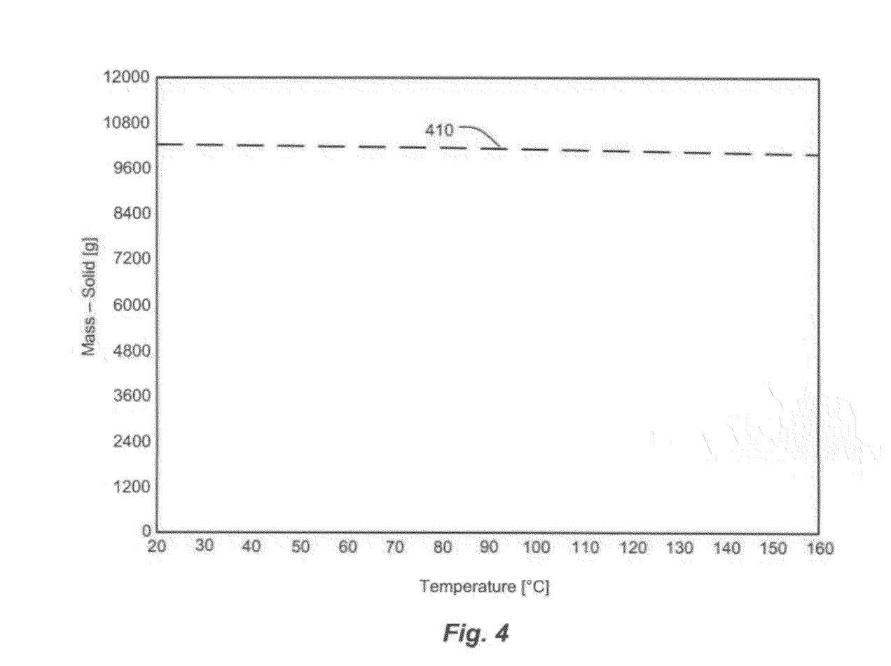

However, a more serious issue is that a diverting plug created with NaCl may not readily dissolve under downhole conditions, and may not clean up. This is counter intuitive considering the fact that NaCl is highly soluble. Ideally, a degradable diverting plug should be able to “dissolve” in the water that is contained within the plug itself. That is ΔV_{sf}^{bd} should not depend on any additional water or brine being added to or washed through the plug. Although NaCl is highly soluble, its solubility is a weak function of temperature and has practically no dependence on pressure as can be seen in FIG. 4. Therefore, we cannot rely on the rising local temperature to assist in the decomposition of the diverting plug. Under some circumstances, this may have significant negative consequences for the eventual cleanup of the plug.

FIG. 4 is a graph showing how the solid mass of an NaCl plug changes as a function of temperature and pressure, according to some embodiments. Such changes could occur, for example after the plug is placed and starts warming up to BHST. The plug's composition is 1.02 kg solid NaCl particulates and 0.374 kg of saturated brine, which corresponds to a plug with a solid volume fraction of V_{sf}^{b}=0.58 when placed. The curve 410 shows the solid mass plotted versus temperature. The curve 410 is the same for pressures of 2000, 4000, 6000, 8000, 10000, and 12000 psia.

During placement of a bridging plug the solid volume fraction of the local slurry concentrates due to particulates interacting with the walls of the fracture until V˜0.60. This means that for every 1.02 kg of NaCl, there is 0.374 kg of residual saturated brine in the created diversion plug. Since the solubility of NaCl does not change markedly with temperature as can be seen from FIG. 4, the plug will not self degrade as the temperature increases. In order for the plug to re-dissolve and cleanup, flowback fluid and production water passing back over, around and through the plug is required in order to clean it up.

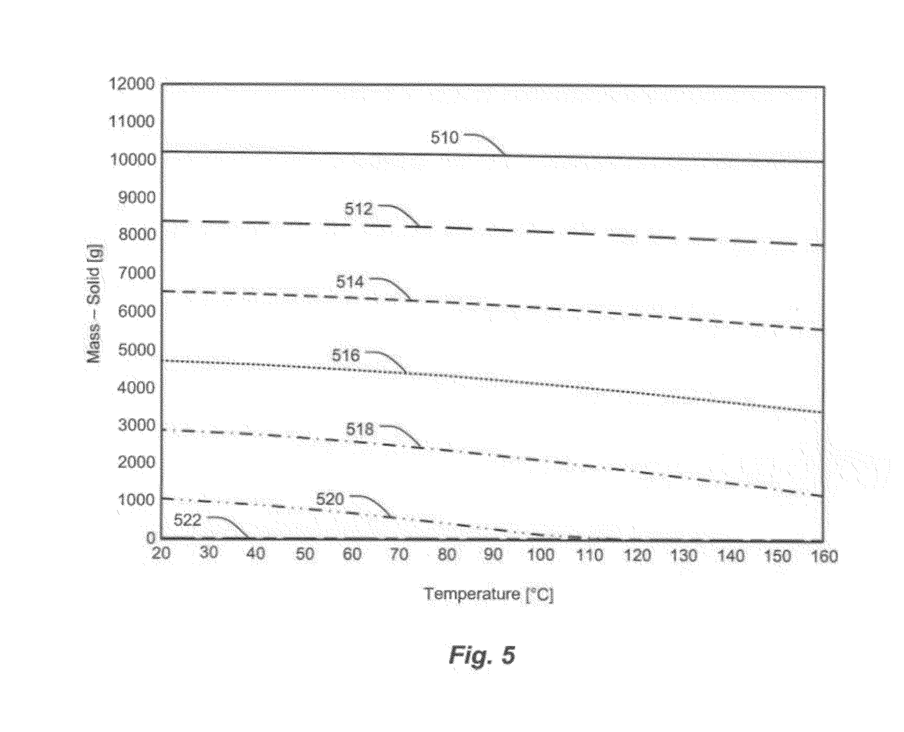

FIG. 5 is a graph showing the solid volume of a NaCl plug at 10,000 psi as a function of temperature, and as a function of increasing water, according to some embodiments. The NaCl plug plotted in FIG. 5 the same 1.020 kg NaCl V_{sf}^{b}=0.58 plug discussed with respect to FIG. 4. Curves 510, 512, 514, 516, 518, 520 and 522 are for mass−solid−water=0.25 kg, 0.75 kg, 1.25 kg, 1.75 kg, 2.25 kg, 2.75 kg, 3.25 kg, 3.75 kg and 4.00 kg, respectively. The graph shows how much of the plug dissolves as water flows around or through it. In order for this plug to completely dissolve (i.e. completely clean up) and additional 2.50-2.75 L of water will be needed. In practical terms, this means that the plug will not clean up well into flowback or production of the well, if ever. Furthermore, if the water itself is saturated in NaCl, the dissolution process could be substantially longer, and the plug for could be permanent in some situations. In an ultra-low permeability shale formation, the flow of water from the formation is restricted. Likely a diverting plug will see additional water at its edges, and possibly some water coming in from the formation due to the high osmotic potential. As closure stress is added to the NaCl plug during the flowback period it will also greatly reduce the permeability of the NaCl diverting plug—further hindering dissolution. Furthermore, many gas shale formations contain a lot of salt, and the flowback water often contains sodium chloride concentrations as high at 125,000-250,000 ppm. The calculations used to derive the curves of FIG. 5 were assuming that additional pure water (or low concentration residual slickwater) was added to the plug, but if the additional brine is saturated, then further dissolution will not occur and the plug would be thermodynamically stable under those conditions. Clearly, even though NaCl is a highly soluble salt it could form a relatively difficult to remove diverting plug in a fracture. Thus, high solubility is not the key physical feature for a material to make a good diverting agent. Temperature and pressure dependence of the solubility are much more important features.

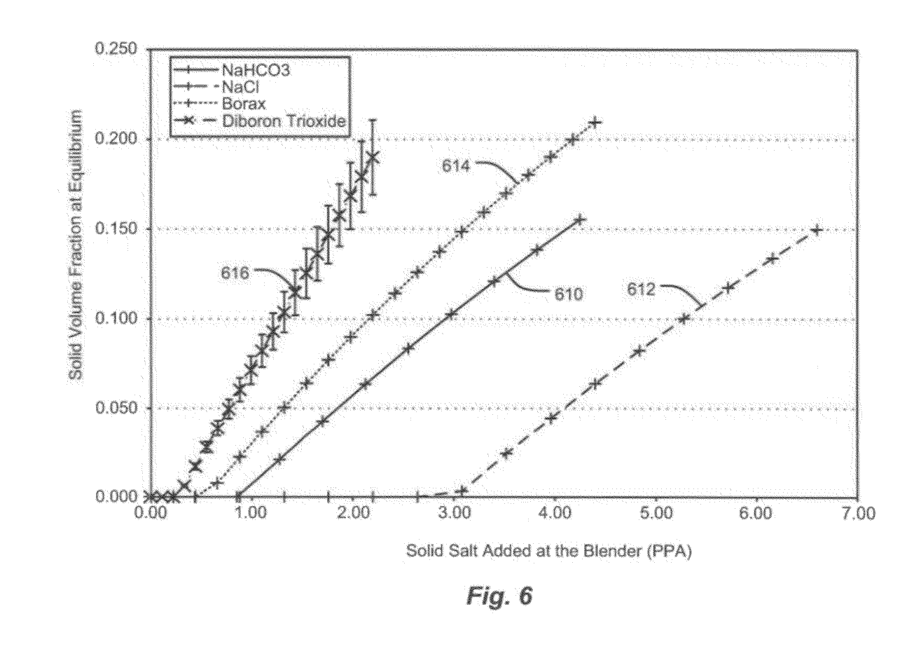

Example of Diverting Plugs Containing Borax (Na₂B₂O₇.10H₂O), Diboron Trioxide (B₂O₃), Boric Acid (B(OH)₃), and Other Boron Containing Salts. For a material to be a good diverting agent it should have relatively low solubility in the fracturing fluid at ambient surface conditions, and relatively high solubility at downhole conditions (high temperature and pressure). Diverting plugs created with borax, diboron trioxide, boric acid or related borate species meet this criterion. FIG. 6 is a graph comparing the equilibrated solid volume fractions when the temperature is 25° C., and the pressure is 3000 psi for a number of inorganic materials as a function of the added material, according to some embodiments. In particular, curve 610 is for NaHCO₃, curve 612 is for NaCl, curve 614 is for Borax, and curve 616 is for diboron trioxide. In order to achieve a V_{sf}ⁱ=0.10, only 2.2 PPA of borax is required, versus 5.3 PPA of NaCl (rock salt). Furthermore, as can be seen from Table 1, the ionic strength of the fracturing fluid is much lower for the saturated borax solution than for the saturated sodium chloride solution.

TABLE 1
Comparisons of the required additive concentrations to achieve
a reasonable solid volume fraction of Vsfi = 0.10, and
a comparison of the ionic strengths of the saturated solutions

| | PPA to Achieve | Ionic Strength of |
|---|---|---|
| | V_{sf}ⁱ = 0.10 | Saturated Solution at |
| Species | (PPA) | 25 deg C. (mol/mol) |
| NaCl | 5.28 | 0.0912 |
| NaHCO₃ | 2.98 | 0.0170 |
| Borax | 2.20 | 0.0075 |
| B₂O₃ | 1.32 | 5.11E−06 |
| PLA (XE100) | 1.11 | 0.00E+00 |

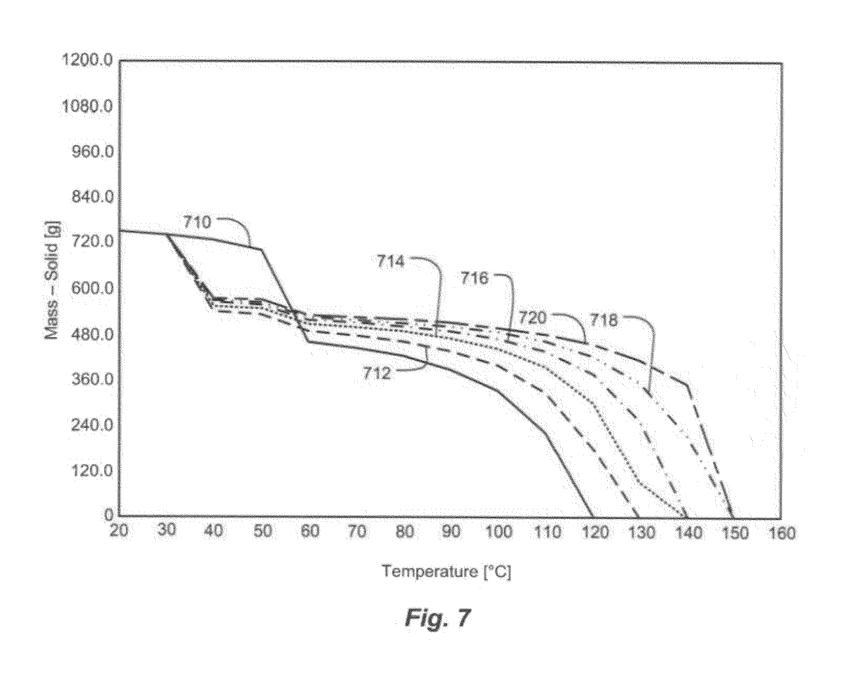

FIG. 7 is a graph showing how the solid mass of a diversion plug made with borax will change as a function of temperature and pressure, according to some embodiments. In particular, curves 710, 712, 714, 716, 718 and 720 plot the solid mass of a diversion plug versus temperature for pressures of 2000, 4000, 6000, 8000, 10000, and 12000 psia, respectively. The composition of the plug upon placement, using the 10,000 psi curve 718, is 753.4 kg solid borax particulates and 311.04 kg of saturated borate solution. This corresponds to a plug with a solid volume fraction of V_{sf}^{b}=0.61 when placed.

In contrast to sodium chloride, the solubility of borax and it its family of related borates is highly dependent on both temperature and pressure as shown in FIG. 7. A porous diverting plug created with borax will clearly undergo dissolution in its internal fluids as its temperature increases. If conditions are considered such as where the static BHST is approximately 150° C., and the bottomhole pressures during pumping are in the range of 10,000-12,000 psi, it can be seen that a plug created at a low temperature, will likely clean up in entirety as the bottomhole temperature rises to approach the BHST. Any pressure drawdown on the borax diversion plug will also facilitate dissolution.

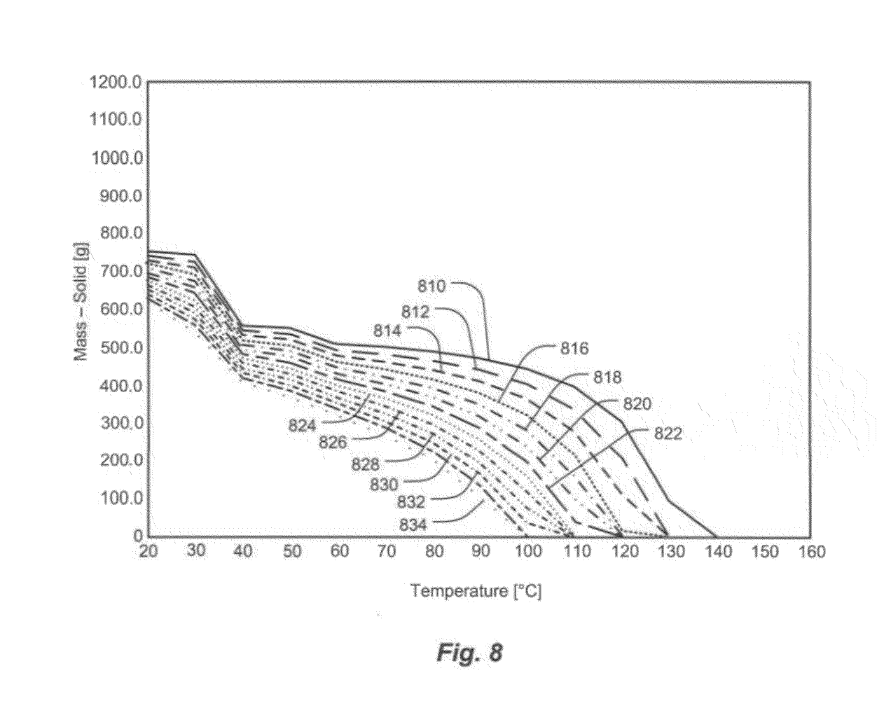

A borax diverting plug may not contain sufficient water to completely self degrade in lower temperature formations. In these conditions additional water from the fracture network, or produced water from the formation will be required to completely dissolve a simple plug made from borax. FIG. 8 is a graph showing how much additional water is required for a borax plug to be removed when the static pressure is 6,000 psi, according to some embodiments. The graph of FIG. 8 is for the same 753.4 kg borax V_{sf}^{b}=0.61 plug discussed in FIG. 7 above. FIG. 8 shows the solid volume of the plug at 6,000 psi as a function of temperature, and as a function of increasing water. In particular curves 810, 812, 814, 816, 818, 820, 824, 826, 828, 830, 832 and 834 are for water amounts of 0.3, 0.5, 0.7, 0.9, 1.1, 1.3, 1.5, 1.7, 1.9, 2.1, 2.3, 2.5, and 2.7 kg, respectively. The graph of FIG. 8 can be used to show how much of the plug dissolves as water flows around or through it. In order for this plug to completely dissolve at BHST—100° C. (completely clean up) an additional 2.50 L of water will be needed. In practical terms, this means that the plug will not clean up well into flowback or production of the well, if ever. At temperatures of 100° C., a borax plug would require an additional 2.500 L of water to completely dissolve. As discussed above in the NaCl selection, this reliance on additional water for cleanup may be less than ideal. It would be helpful to have assisted degradation when borax plugging agents are deployed in lower temperature formations.

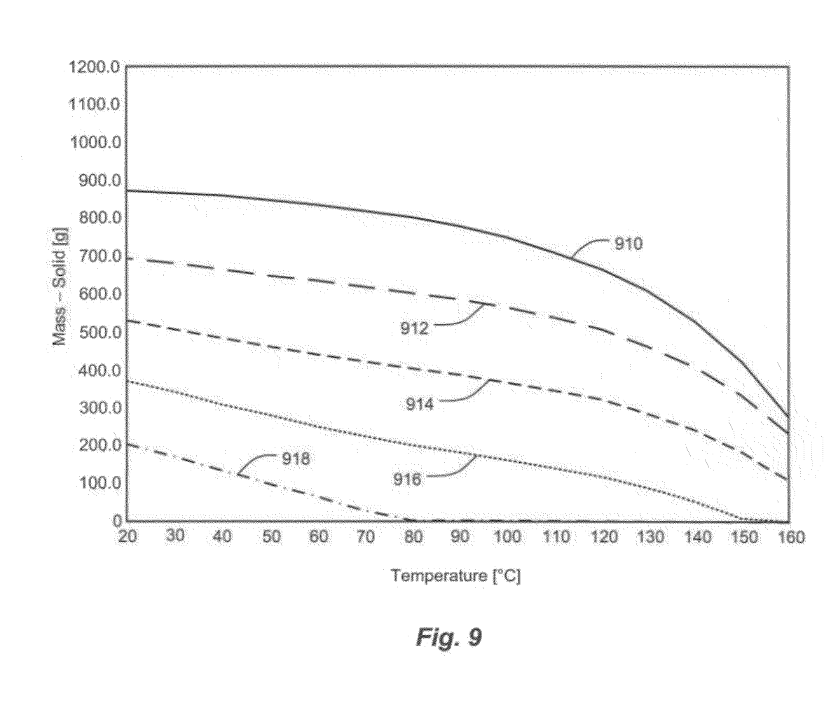

One method of assisting the degradation of the boron based plugs at lower temperature is through the inclusion of slowly soluble bases such as magnesium oxide (MgO). FIG. 9 is graph illustrating how a V_{sf}^{b}=0.60 solid fraction plug initially made with B₂O₃ dissolves as a function of temperature, according to some embodiments. The graph of FIG. 9 is for the same 753.4 kg borax V_{sf}^{b}=0.61 plug originally made with B₂O₃ particulate. It shows the solid volume of the plug at 6,000 psi as a function of temperature, and as a function of increasing concentration of MgO. In particular, curves 910, 912, 914, 916, and 918 are for MgO concentrations of 0.0, 0.620282, 1.24056, 1.86084, and 2.48112 mol, respectively. As the temperature rises this plug becomes completely soluble in the water contained in it. FIG. 9 illustrates a major feature various embodiments, that the extent of decomposition can be tuned by the addition of other reactive species, or by controlling the pH of the fluid.

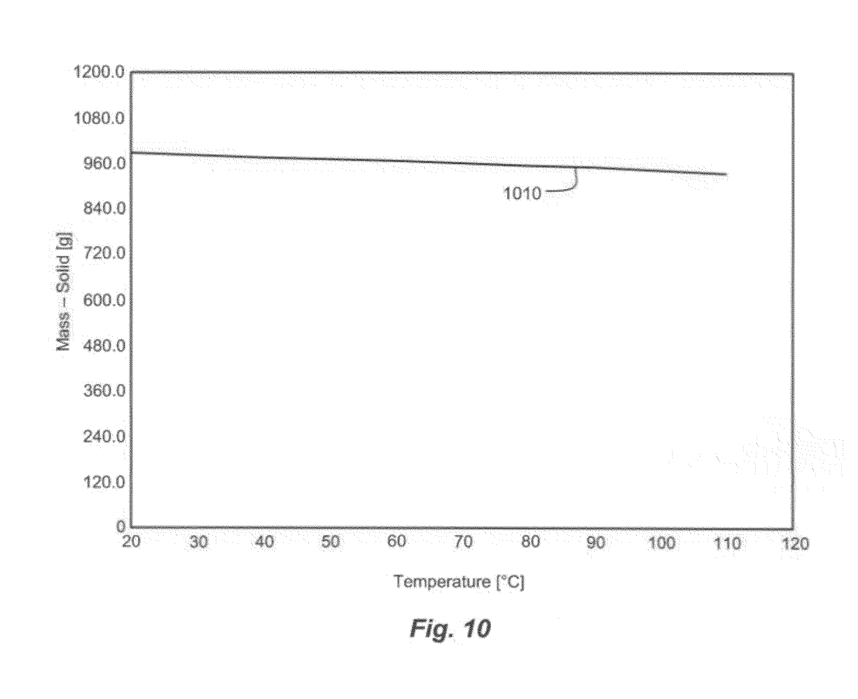

Example of Diverting Plugs Containing Sodium Bicarbonate (NaHCO₃) and Kinetic Control by Using Barriers, Encapsulation, Acid Precursors or Delayed Reactive Species. Sodium bicarbonate is another good material for degradable plugs. It is significantly less soluble than sodium chloride at ambient surface temperature as shown in FIG. 5 and Table 1, so less material is required in order to create a slurry capable of bridging. However, by itself its solubility is only slightly temperature dependant at high hydrostatic pressures as shown in FIG. 10.

FIG. 10 is a graph showing how the solid mass of a NaHCO₃ plug changes as a function of temperature and pressure, according to some embodiments, (for example after the plug is placed and starts warming up to BHST). The plugs composition is 1.02 kg solid NaHCO₃ particulates and 0.295 kg of saturated brine. This corresponds to a plug with a solid volume fraction of V_{sf}^{b}=0.61 when placed. Note that the graphs shown cover relatively wide temperature and pressure ranges that a diverting slurry or plug would experience in the field. In particular, curve 1010 represents all of the pressures of 1000, 2000, 3000, 4000, 5000 and 6000 psia.

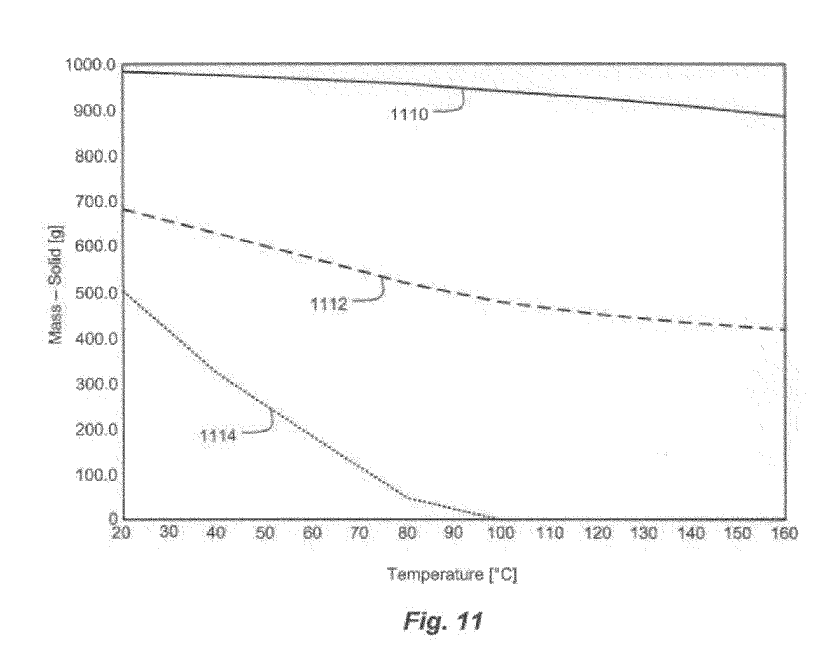

If encapsulated sodium bicarbonate is combined with an encapsulated acid, or slowly soluble ester, a temporary diverting plug can be created that degrades. Previous discussions of some embodiments have shown that temporary diverting plugs could be engineered primarily on the basis of the thermodynamics of their constituents. However, according to some embodiments two or more reactive species are incorporated in the same plug, and the reaction is delayed until the desired time or temperature is reached, so as to gain greater control on the ΔV_{sf}^{bd}. According to some embodiments this is accomplished using chemical barriers, temporary encapsulation, and time-dependent reactive chemicals. FIG. 11 is a graph showing the sensitivity of a sodium bicarbonate plug to the addition of citric acid, according to some embodiments. FIG. 11 shows how the solid mass of a NaHCO₃ plug changes as a function of temperature and the addition of citric acid. The initial mass of NaHCO₃ was 0.985 kg and the initial mass of water was 0.295 kg in this modelling experiment. Curves 1110, 1112 and 1114 represent 0.0 kg, 0.4 kg and 0.8 kg of citric acid, respectively.

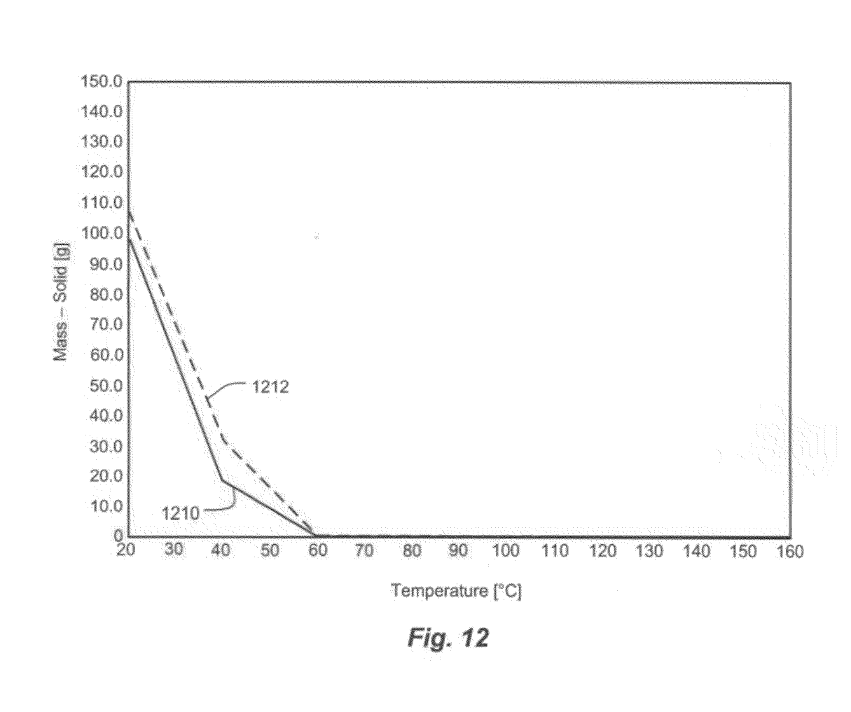

FIG. 12 is a graph showing a modelling experiment that simulates the reaction after the encapsulation ruptures of a combination citric acid/sodium bicarbonate plug, according to some embodiments. FIG. 12 shows the solid mass of an encapsulated NaHCO₃/encapsulated citric acid combination plug as a function of temperature after reaction (what could occur if the NaHCO₃ particles were encapsulated with a time dependent or heat activated coating). For this modeling experiment the initial mass was 0.500 kg and the initial mass of citric acid was 0.500 kg. The solid volume fractions at the time of mixing and the time of bridging were respectively V_{sf}ⁱ˜0.11 and V_{sf}^{b}˜0.62. The only water was that in the interstitial pores of the packs (V_{H20}=300 mL). Curves 1210 and 1212 represent pressures of 3000 and 6000 psia, respectively. According to some embodiments, this plug is placed in a reservoir with a BHST in excess of 60° C., where it completely dissolves in its own interstitial water.

Those skilled in the art will recognize that some embodiments will be deployed as a component of a larger, more complicated wellbore stimulation and completion service. As such some embodiments will be used in combination with other fracturing fluid components such as friction reducers, biocides, clay stabilizers, surfactants, and viscosity breakers. It will also be recognized that some embodiments will be deployed using well site delivery equipment such as blenders, pumps and coiled tubing equipment. On these completions often wireline and slickline equipment is used as part of the overall service. The overall completion is usually designed using specialized software that simulates the treatment being pumped. The utility of such embodiments can be enhanced if judicious choices are made when selecting these auxillary technologies, materials and equipment for deployment along with these embodiments.

According to some embodiments, the techniques described herein can be combined with one or more of the following other technologies: salt tolerant friction reducers; instrumented coiled tubing; and properly calibrated temperature simulators. The use of salt tolerant friction reducers can greatly reduce the pumping pressure when fluids with high ionic strengths—such that will occur when materials as described herein are deployed—are pumped. Since the real-time bottom hole temperature and pressure are an important controlling factors for both the rate and extent of plug dissolution, it stands to reason that better understanding of the temperature and pressure regimes in the wellbore will lead to better control, and greater utility, of the techniques and materials described herein. As such, instrumented coiled tubing where either temperature, pressure or both are measured in real time will prove very useful when deployed with the materials described herein. Real-time and memory based temperature gauges deployed using electric wireline and slickline will also create value. Furthermore, more accurate and better calibrated temperature simulators will also increase the utility of the described materials.

As previously discussed, the shape of the particulate material, whether they are spherical particles, irregular granules, platelets, or in a chopped fibrous form, has a major impact on their bridging characteristics in well bores, perforations or fractures. Similarly the size of the particulate material, their characteristic radius or length also plays a major role in determining the space filling volume fraction, V_{sf}^{b}, required for bridging to occur, and for plug formation to commence. Similarly, specific surface treatments such as adhesives or lubricants on the particulate, or on a portion of the particulate material will also greatly influence the space filling volume fraction required to initiate bridging V_{sf}^{b}. By judicious selection of particulate size, shape and surface treatment, specific embodiments can be optimized for specific treatment and economic conditions. For example, the total material required for a treatment could be reduced by choosing a fibrous embodiment over particulate that is spherical. Similarly fibrous or adhesive embodiments could be chosen for situations, such as wide fractures, which are very hard to bridge. Alternatively, in other situations cost may be reduced by using a granular materials that less expensive to manufacture.

As those knowledgeable with the art of hydraulic fracturing know, the optimum placement of the plug or plugs depends on the specific situation, and the requirements of the overall completion service. In some embodiments it is best if the plug or plugs are placed in the fracture, fractures or fracture network, beyond the well bore itself. This embodiment has the advantage in that it facilitates post-treatment operations in the wellbore such as pump-down perforation guns, bridge plug placement, etc. Alternatively, in some embodiments the diversion plug can be placed in the perforation tunnels, or in the wellbore itself. This embodiment has the advantage that it is much easier to calculate and place, and that it possibly will be cooler—facilitating longer plug lifetime for low temperature materials.

Although many of the embodiments have been described as applying to hydraulic fracturing applications, the techniques described herein, according to some embodiments can also be applied to other types of wellbore stimulations such as: water control, acidizing, acid fracturing, and fluid loss applications.

Whereas many alterations and modifications of the present disclosure will no doubt become apparent to a person of ordinary skill in the art after having read the foregoing description, it is to be understood that the particular embodiments shown and described by way of illustration are in no way intended to be considered limiting. Further, the disclosure has been described with reference to particular preferred embodiments, but variations within the spirit and scope of the disclosure will occur to those skilled in the art. It is noted that the foregoing examples have been provided merely for the purpose of explanation and are in no way to be construed as limiting of the present disclosure. While the present disclosure has been described with reference to exemplary embodiments, it is understood that the words, which have been used herein, are words of description and illustration, rather than words of limitation. Changes may be made, within the purview of the appended claims, as presently stated and as amended, without departing from the scope and spirit of the present disclosure in its aspects. Although the present disclosure has been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed is:

1. A wellbore service fluid comprising:
an aqueous medium; and
sodium bicarbonate in sufficient concentration in the aqueous medium so as to act as a diverting agent during a treatment procedure using the fluid.

2. A fluid according to claim 1 wherein the concentration of sodium bicarbonate is greater than about 5 kg per 1000 liters of aqueous medium.

3. A fluid according to claim 2 wherein the concentration of sodium bicarbonate is greater than about 96 kg per 1000 liters of aqueous medium.

4. A fluid according to claim 1 further comprising a hydrolysable ester.

5. A fluid according to claim 4 wherein the hydrolysable ester is selected from a group consisting of ethyl acetate, ethyl lactate, lactide, polylactic acid, and polyglycolic acid.

6. A fluid according to claim 1 wherein the sodium bicarbonate is formed into particles.

7. A fluid according to claim 6 wherein the particles are a composite of the sodium bicarbonate and one or more other materials.

8. A fluid according to claim 6 wherein the particles are encapsulated.

9. A fluid according to claim 1 further comprising a retarded acid source.

10. A fluid according to claim 1 further comprising one or more materials selected from the group consisting of benzoic acid, polylactic acid, and polyglycolic acids.

11. A fluid according to claim 1 wherein the treatment procedure is a hydraulic fracturing procedure.

12. A fluid according to claim 1 wherein the treatment procedure is of a type selected from a group consisting of: water control, acidizing, acid fracturing, and fluid loss control.

13. A method of treating a subterranean formation penetrated by a wellbore, the method comprising:
providing a wellbore service fluid according to claim 1; and
pumping the fluid through the wellbore.

14. A method according to claim 13 wherein the treatment is a hydraulic fracturing treatment and the pumping of the fluid is at pressure sufficient to fracture the formation.

15. A method according to claim 13 further comprising diverting flow of the fluid at least in part through formation of at least one plug that includes sodium bicarbonate.

16. A method according to claim 15 further comprising substantially dissolving the plug at least in part due to changes in temperature and/or pressure.

17. A method according to claim 16 wherein the dissolution of the plug uses substantially no additional water than is present due to the pumping the fluid through the wellbore and into the subterranean formation.

18. A method according to claim 16 wherein the dissolving of the plug releases a beneficial substance into the formation.

19. A method according to claim 18 wherein the beneficial substance is at least one of a scale inhibitor and oxidizer.

20. A method according to claim 15 wherein the plug is formed in at least one of the subterranean formation, the wellbore, and perforation tunnel.

21. A wellbore service fluid comprising:
an aqueous medium; and
a material containing water in a crystal structure of the material, in sufficient concentration in the aqueous medium so as to act as a diverting agent during a treatment procedure using the fluid.

22. A fluid according to claim 21 wherein the material is a salt.

23. A fluid according to claim 21 wherein the concentration of the material containing water in the crystal structure of the material is greater than about 3 kg per 1000 liters of aqueous medium.

24. A fluid according to claim 23 wherein the concentration of the material is greater than about 30 kg per 1000 liters of aqueous medium.

25. A fluid according to claim 21 wherein the material is a chemical compound that contains at least one boron-oxygen bond.

26. A fluid according to claim 25 wherein the chemical compound is selected from a group consisting of: tincal, tincalonite, kernite, colemanite, ulexite, proberite, hydroboracite, inderite, dalotite, boron trioxide, szaibelyite, sodium perborate, and sassolite B(OH)₃.

27. A fluid according to claim 21 wherein material contains one or more sulfate salts.

28. A fluid according to claim 27 wherein the one or more sulfate salts includes sodium sulfate decahydrate (Na₂SO₄.10H₂O).

29. A fluid according to claim 21 wherein material contains one or more aluminum sulfates.

30. A fluid according to claim 29 wherein the one or more aluminum sulfates are selected from a group consisting of: ammonium aluminum sulfate ((NH₄)Al(SO₄)₂.12H₂O), potassium aluminium sulfate (KARSO₄)₂.12H₂O), and sodium aluminium sulfate ((NH₄)Al(SO₄)_{.}12H₂O).

31. A fluid according to claim 21 wherein the material contains one or more phosphates.

32. A fluid according to claim 29 wherein the one or more phosphates are selected from a group consisting of: sodium pyrophosphate decahydrate (Na₂P₂O₇.10H₂O), sodium hydrogen orthophosphate dodecahydrate (Na₂HPO₄.12H₂O), magnesium potassium phosphate hexahydrate (MgKPO₄.6H₂O), and the anhydrous or partially hydrated salts of these species.

33. A fluid according to claim 21 wherein the treatment procedure is a hydraulic fracturing procedure.

34. A method of fracturing a subterranean formation penetrated by a wellbore, the method comprising:
providing a wellbore service fluid according to claim 21; and
pumping the fluid through the wellbore and into the subterranean formation at a pressure sufficient to fracture the formation.

35. A method according to claim 34 further comprising diverting flow of the fluid at least in part through formation of at least one plug that includes the material.

36. A method according to claim 35 further comprising substantially dissolving the plug at least in part due to changes in temperature and/or pressure, wherein the dissolving of the plug releases a scale inhibitor into the formation.

37. A method according to claim 35 wherein the plug is formed in at least one of the subterranean formation, the wellbore and a perforation tunnel.

38. A wellbore service fluid comprising:
an aqueous medium; and
a material containing at least one boron-oxygen bond, the material being in sufficient concentration in the aqueous medium so as to act as a diverting agent during a treatment procedure using the fluid.

39. A fluid according to claim 38 wherein the material is selected from the group consisting of: granular borax, tincal, tincalonite, kernite, colemanite, ulexite, proberite, hydroboracite, inderite, dalotite, boron trioxide, szaibelyite, sassolite B(OH)₃, diboron trioxide, boron oxide and sodium perborate.

40. A fluid according to claim 38 wherein the material is formed into particles that are encapsulated.

41. A fluid according to claim 40 wherein the particles are encapsulated using a polymeric barrier.

42. A fluid according to claim 40 wherein the particles are encapsulated using a polymer barrier of polylactic acid.

43. A fluid according to claim 38 wherein the material has a surface treatment from the group consisting of: adhesive; temporarily adhesive, lubricant and associative mechanism.

44. A fluid according to claim 38 further comprising a high salt stability friction reducers.

45. A fluid according to claim 38 further comprising a polylactic acid and polyglycolic based diverting agents.

46. A method of fracturing a subterranean formation penetrated by a wellbore, the method comprising:
providing a wellbore service fluid according to claim 38; and
pumping the fluid through the wellbore and into the subterranean formation at a pressure sufficient to fracture the formation.

47. A method according to claim 46 further comprising diverting flow of the fluid at least in part through formation of a plug that includes the material containing at least one boron-oxygen bond.

48. A method according to claim 47 further comprising substantially dissolving the plug at least in part due to changes in temperature and/or pressure.

49. A method according to claim 48 wherein the dissolution of the plug releases at least one of a scale inhibitor and an oxidizer into the formation.

50. A method of fracturing a subterranean formation penetrated by a wellbore, the method comprising:
combining at least a first reactive chemical and a second reactive chemical in an aqueous medium at a pressure of at least 500 psi to form a wellbore service fluid; and
pumping the service fluid through the wellbore and into the subterranean formation at a pressure sufficient to fracture the formation.

51. A method according to claim 50 further comprising diverting flow of the fluid at least in part through formation of a plug that includes the first and second reactive chemicals.

52. A method according to claim 51 further comprising substantially dissolving the plug at least in part due to changes in temperature and/or pressure, wherein the dissolving of the plug releases a beneficial substance into the formation.

53. A method of selecting an appropriate diverting agent for use in a hydraulic fracturing operation, the method comprising:
calculating thermodynamic characteristics for a plurality of candidate diverting agent;
calculating solubility characteristics for a plurality of candidate diverting agents;
selecting a diverting agent from among the plurality of candidate diverting agents based at least in part on the calculated thermodynamic and solubility characteristics.

54. A method according to claim 53 wherein the diverting agent is selected agent is selected based in part on having an acceptably low solubility at low temperatures and an acceptably high solubility at high temperatures.

55. A method according to claim 54 wherein the low temperatures is approximately an expected ambient surface temperature.

56. A method according to claim 54 wherein the high temperatures is approximately an expected bottom hole static temperature.
